(19) United States
(12) Patent Application Publication
(10) Pub. No.: US 2014/0047021 A1
(43) Pub. Date: Feb. 13, 2014

(54) METHOD AND SYSTEM FOR PROCESSING INFORMATION

(71) Applicants: Sean Patrick KENNEDY, San Diego, CA (US); Rowell R. DOMONDON, San Diego, CA (US)

(72) Inventors: Sean Patrick KENNEDY, San Diego, CA (US); Rowell R. DOMONDON, San Diego, CA (US)

(73) Assignee: SONY CORPORATION, Tokyo (JP)

(21) Appl. No.: 13/571,698

(22) Filed: Aug. 10, 2012

(51) Int. Cl. G06F 15/16

(52) U.S. Cl. 709/204; 709/226

(57) ABSTRACT

Certain aspects of a system and/or method for processing information may include a server computing device. The server computing device may aggregate data associated with a user received from one or more data sources. The data may depend on a pre-defined distance range from a location of the user. At least one tag value may be associated with each element of the aggregated received data. The associated at least one tag value may uniquely identify each element of the aggregated received data.

### CROSS-REFERENCE TO RELATED APPLICATIONS/INCORPORATION BY REFERENCE

None

### FIELD

Certain embodiments of the disclosure relate to a communication system. More specifically, certain embodiments of the disclosure relate to a method and system for processing information.

### BACKGROUND

In general, people may want to be aware of various types of information related to their family, friends, surroundings, travel information, information about products and/or services available in a geographical area near them, and other similar information. Developments in mobile communication systems have enabled people to access information about various subjects using communication networks. However, the information is often scattered and disorganized resulting in an unsatisfactory user experience.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A system and/or method is provided for processing information substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating processing information in an exemplary network, in accordance with an embodiment of the disclosure.

FIG. 2 is a block diagram of an exemplary server computing device, in accordance with an embodiment of the disclosure.

FIG. 3 is a block diagram of an exemplary client computing device, in accordance with an embodiment of the disclosure.

FIG. 4 is a flow chart illustrating exemplary steps for aggregation of data at a server computing device, in accordance with an embodiment of the disclosure.

FIG. 5 is a flow chart illustrating exemplary steps for displaying data at a client computing device, in accordance with an embodiment of the disclosure.

FIGS. 6a and 6b is a flow chart illustrating exemplary steps for processing information, in accordance with an embodiment of the disclosure.

FIG. 7 is an exemplary user interface displayed on a client computing device, in accordance with an embodiment of the disclosure.

### DETAILED DESCRIPTION

Certain implementations may be found in a system and/or method for processing information. Exemplary aspects of the disclosure may comprise a server computing device. The server computing device may aggregate data associated with a user received from one or more data sources. The aggregated received data may correspond to a pre-defined distance range from a location of the user. The server computing device may associate at least one tag value with each element of the aggregated received data. The associated at least one tag value may uniquely identify each element of the aggregated received data.

The server computing device may generate a set of data associated with the user from the aggregated received data based on one or more of the location of the user, an online social network of the user located within the pre-defined distance range, the associated at least one tag value, and/or a pre-defined user preference of the user. The server computing device may communicate the generated set of data in a pre-defined format to a client computing device.

The server computing device may assign a weight to each element of the aggregated received data based on one or more parameters. The generated set of data may be determined based on the assigned weight. The one or more parameters may comprise one or more of a distance from the location of the user, a demographic profile of the user, metadata associated with the user, a time of occurrence of an event, the user's profile, and/or a frequency of the user's visit to a data source. The metadata associated with the user may comprise one or more of the user's Internet browsing history, a frequency of the user's visit to a place of interest, information posted by the user on a social networking website, and/or a review posted by the user on a review website. The one or more data sources may be selected by the user. The one or more data sources may comprise one or more of a social networking server, a news server, a review website server, and/or a weather information server. The received data comprises one or more of a user profile of the user, user profiles of other users within the online social network of the user, an update associated with the online social network of the user, information about social gatherings, information posted by the user and/or the other users on a social networking website, news feeds, news related to a local area, event information from a local news website, one or more reviews about food, restaurants, books, movies, people, products, and/or events, current and/or forecasted weather information about an area, information about local deals in an area, places of interest in an area, and/or advertisements related to local products. The associated at least one tag value may be determined based on one or more of a keyword, a data source associated with each element of the aggregated received data, metadata related to an image, and/or a relationship with the user. The associated at least one tag value may comprise one or more of food, an event, a place, news, a sale, or a distance range from the location of the user.

Exemplary aspects of the disclosure may comprise a client computing device associated with a user. The client computing device may communicate a location of the user to a server computing device. The client computing device may receive a set of data associated with the user. The received set of data may correspond to a pre-defined distance range from a location of the user. The client computing device may display the received set of data on the client computing device.

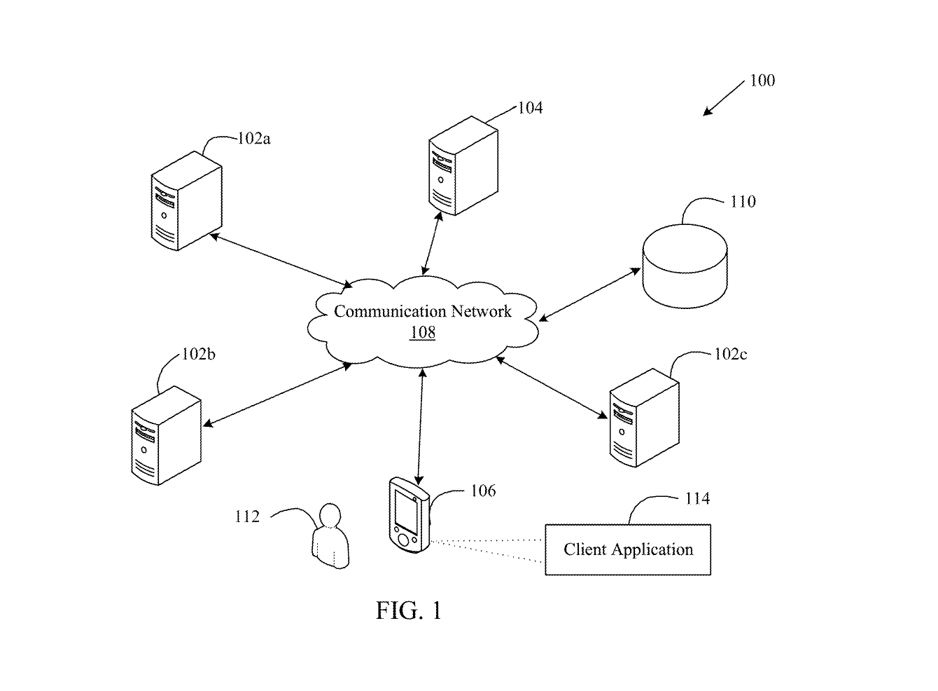

FIG. 1 is a block diagram illustrating processing information in an exemplary network, in accordance with an embodiment of the disclosure. Referring to FIG. 1, there is shown a network 100. The network 100 includes one or more data sources, such as, a social networking server 102a, a news server 102b, and a review website server 102c (hereinafter referred to as data source(s) 102), a server computing device 104, a client computing device 106, a communication network 108, a database 110, and a user 112. The client computing device 106 is associated with the user 112. The client computing device 106 may comprise a client application 114. Although FIG. 1 shows only one client computing device (such as the client computing device 106) and only one user (such as the user 112) for simplicity, one skilled in the art may appreciate that the disclosed embodiments may be implemented for a large number of client computing devices and/or users.

The data source(s) 102, the server computing device 104, and the client computing device 106 may be operable to communicate with each other via the communication network 108. The data source(s) 102, the server computing device 104, and the client computing device 106 may be operable to connect to the communication network 108, in accordance with various wired and wireless communication protocols such as Transmission Control Protocol and Internet Protocol (TCP/IP), User Datagram Protocol (UDP), Hypertext Transfer Protocol (HTTP), or File Transfer Protocol (FTP). Examples of the communication network 108 may include, but are not limited to, the Internet, a Wireless Fidelity (Wi-Fi) network, a Wireless Local Area Network (WLAN), a Local Area Network (LAN), or a Metropolitan Area Network (MAN).

The social networking server 102a may comprise suitable logic, circuitry, interfaces, and/or code that may be operable to host a social networking website. The user 112 may connect with other users in the network 100 through the social networking website and form an online social network of the user 112. The online social network of the user 112 may include other users that connect to the user 112 through the social networking website. The social networking server 102a may provide data associated with the hosted social networking website. Examples of such data may include, but are not limited to, a user profile of the user 112, user profiles of the other users forming the online social network of the user 112, an update associated with the online social network of the user 112, information about social gatherings, and/or information, for example, an image and/or a comment posted by the user 112 and/or the other users on the social networking website.

The news server 102b may comprise suitable logic, circuitry, interfaces, and/or code that may be operable to host a news website. Examples of news websites may include, but are not limited to, New York Times, Washington Post, Wall Street Journal (WSJ), and the like. Examples of data that the news server 102b may provide may include, but are not limited to, news feeds, local news related to an area, and/or event information from a local news website.

The review website server 102c may comprise suitable logic, circuitry, interfaces, and/or code that may be operable to host a review website. The review website refers to a website on which website users provide reviews about people, products, businesses, and/or services, for example. The website users may provide reviews by posting comments and/or providing ratings. The review websites may collect reviews from website users or may employ professional writers to write reviews about any topic of interest to website users. Examples of such review websites may include yelp.com, dpreview.com, epinions.com, and the like. The user 112 and/or the other users may provide review about food, restaurants, books, movies, events, locations, consumer products, music, and the like on the review website. Such reviews may help the user 112 to make decisions, such as what products and/or services to purchase, which restaurants serves good food, and/or which book to read. The review website server 102c may provide data related to the reviews posted on the review website to the user 112.

Another example of the data source(s) 102 may include a weather information server that may provide current and/or forecasted weather information about an area. Other servers may also provide information about local deals within an area, within places of interest in an area, and/or advertisements related to local products. Such information may enable the user 112 to know about an area he is visiting, plan travel, purchase local products, and the like

In an embodiment, the social networking server 102a, the news server 102b, the review website server 102c, the weather information server, and the other servers may be cloud based servers.

The data source(s) 102 may comprise suitable logic, circuitry, interfaces, and/or code that may be operable to provide data associated with the user 112. The data source(s) 102 may communicate the data to the server computing device 104. The communicated data may correspond to a collection of data provided by the data source(s) 102. The communicated data may include one or more elements associated with the user 112. The one or more elements of the communicated data may correspond to data communicated, either individually or in combination, by the social networking server 102a, the news server 102b, the review website server 102c, the weather information server, and/or other servers.

In an embodiment, the communicated data may comprise a user profile of the user 112, user profiles of the other users within the online social network of the user 112, an update associated with the online social network of the user 112, information about social gatherings, and/or information posted by the user 112 and/or the other users on the social networking website. The communicated data may also comprise news feeds, news related to a local area, event information from a local news website, one or more reviews about food, restaurants, books, movies, people, products, and/or events, current and/or forecasted weather information about an area, information about local deals in an area, places of interest in an area, and/or one or more advertisements related to local products.

The server computing device 104 may comprise suitable logic, circuitry, interfaces, and/or code that may be operable to process information. The server computing device 104 may receive data from the data source(s) 102. The server computing device 104 may process the received data to generate a set of data associated with the user 112. The generated set of data may include one or more elements associated with the user 112 that are selected from the received data. The server computing device 104 may select the one or more elements associated with the user 112 from the received data.

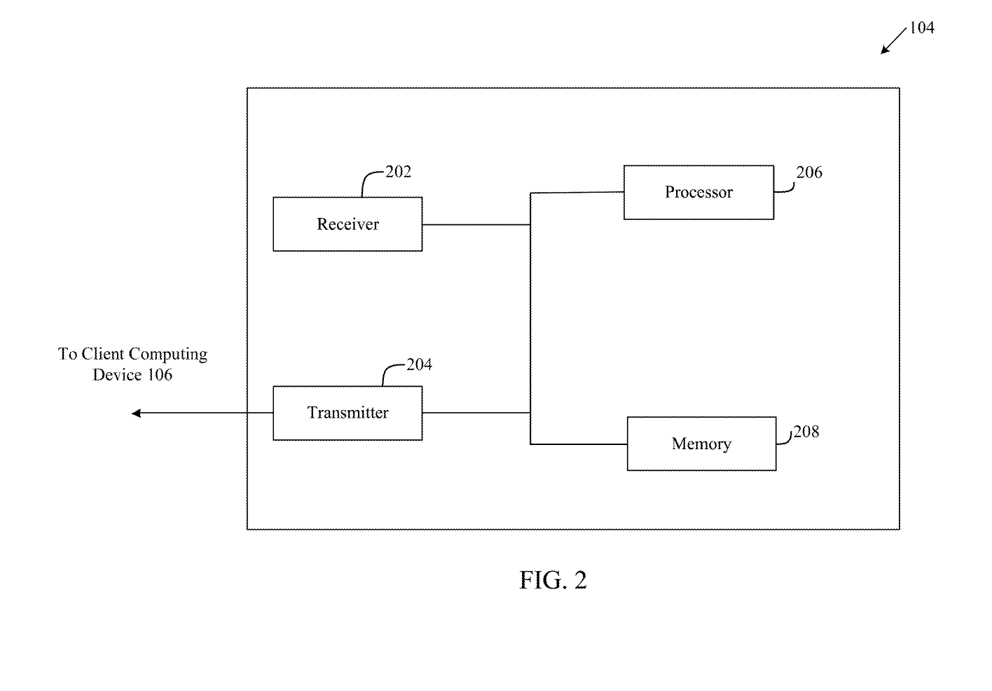

The server computing device 104 may be implemented as a cluster or network of computing devices configured to jointly perform the functions of the server computing device 104. The server computing device 104 may optionally include storage mediums for storing the received data, data related to the client computing device 106, data related to the user 112, data related to other users in the network 100, and/or any other data. The server computing device 104 is described below, in detail, in conjunction with FIG. 2.

The client computing device 106 may comprise suitable logic, circuitry, interfaces, and/or code that may be operable to display the generated set of data. Examples of the client computing device 106 may include, but are not limited to, laptops, tablet computers, mobile phones, and/or Personal Digital Assistant (PDA) devices. In an embodiment, the client computing device 106 may include a web browser application that may enable the user 112 to access, retrieve, and/or view web pages on the Internet. In an embodiment, the client computing device 106 may include a social networking application through which the user 112 may communicate with the social networking server 102a. In an embodiment, the user 112 may use the client computing device 106 to browse the one or more web pages of the social networking website, the review website, the news website, and/or any other website. For example, using the client computing device 106, the user 112 may perform various activities, such as, post comments on the social networking website, view images uploaded by other users on the social networking website, and/or read reviews about products and/or services.

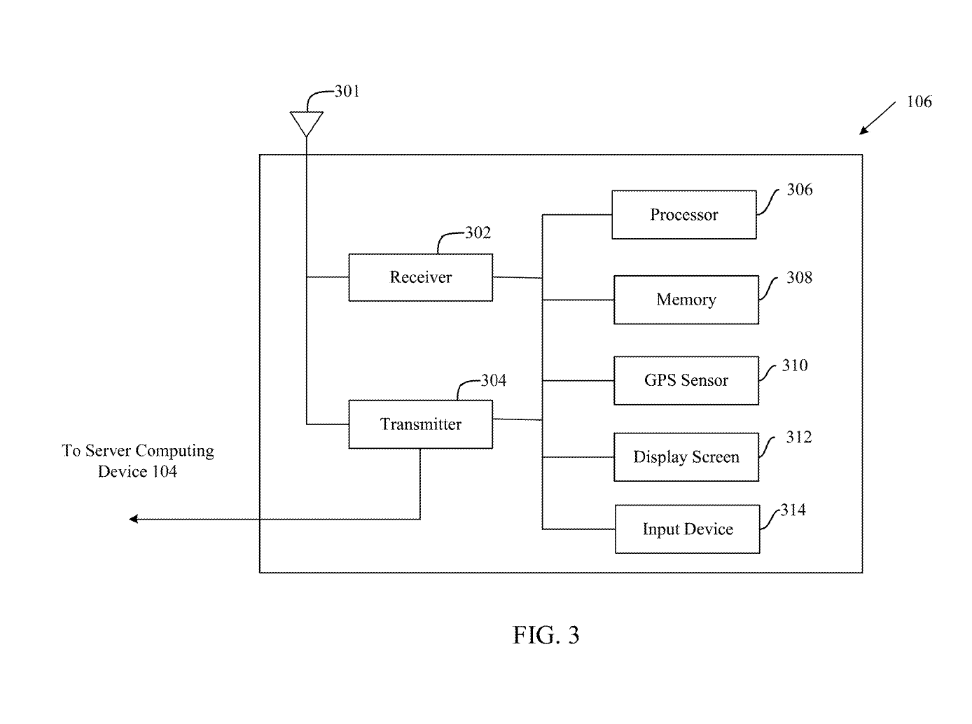

In an embodiment, the client computing device 106 may include a Global Positioning System (GPS) sensor that may determine the location of the client computing device 106. The location of the client computing device 106 may correspond to the location of the user 112 associated with the client computing device 106. The user 112 may install the client application 114 on the client computing device 106. The client application 114 may enable the client computing device 106 to communicate with the server computing device 104. The client computing device 106 is described below, in detail, in conjunction with FIG. 3.

The database 110 may comprise suitable logic, circuitry, interfaces, and/or code that may be operable to store the received data, the generated set of data, data associated with the server computing device 104, the client computing device 106, and the user 112, and/or any other data. In an embodiment, the database 110 may connect to the server computing device 104 via the communication network 108. In another embodiment, the database 110 may be integrated with the server computing device 104. The client computing device 106 may communicate with the database 110 via the communication network 108. The database 110 may be implemented by using several technologies that are well known to those skilled in the art. Some examples of technologies may include, but are not limited to, MySQL® and Microsoft SQL®.

In operation, the client computing device 106 may communicate the location of the user 112 to the server computing device 104 via the communication network 108. Further, the server computing device 104 may receive the data associated with the user 112 from the data source(s) 102 via the communication network 108. The server computing device 104 may aggregate the data received from the data source (s) 102. The aggregated received data may correspond to a pre-defined distance range from the location of the user 112. At least one tag value may be associated with each element of the aggregated received data. The associated at least one tag value may uniquely identify each element of the aggregated received data. The server computing device 104 may generate a set of data associated with the user 112 from the aggregated received data. The server computing device 104 may communicate the generated set of data in a pre-defined format to the client computing device 106 via the communication network 108. The client computing device 106 may display the received set of data to the user 112.

FIG. 2 is a block diagram of an exemplary server computing device, in accordance with an embodiment of the disclosure. The block diagram of the exemplary server computing device is described in conjunction with the block diagram of FIG. 1.

Referring to FIG. 2, there is shown the server computing device 104. The server computing device 104 may comprise a receiver 202, a transmitter 204, one or more processors, such as a processor 206, and a memory 208.

The processor 206 may be communicatively coupled to the receiver 202, the transmitter 204, and the memory 208.

The receiver 202 may comprise suitable logic, circuitry, interfaces, and/or code that may be operable to receive data and/or messages. The receiver 202 may receive data in accordance with various known communication protocols. In an embodiment, the receiver 202 may receive data from the data source(s) 102. In another embodiment, the receiver 202 may receive the location of the user 112 from the client computing device 106. In another embodiment, the receiver 202 may receive a user request for transmitting data to the client computing device 106.

The transmitter 204 may comprise suitable logic, circuitry, interfaces, and/or code that may be operable to communicate data and/or messages. The transmitter 204 may communicate data in accordance with various known communication protocols. In an embodiment, the transmitter 204 may communicate the generated set of data to the client computing device 106. In another embodiment, the transmitter 204 may communicate one or more instructions to the data source(s) 102 for transmitting the data.

The processor 206 may comprise suitable logic, circuitry, and/or interfaces that may be operable to execute at least one code section stored in the memory 208.

The memory 208 may comprise suitable logic, circuitry, and/or interfaces that may be operable to store a machine code and/or a computer program having the at least one code section executable by the processor 206. The memory 208 may further be operable to store data, such as the received data, the generated set of data, the received location of the user 112, a user profile of the user 112, metadata associated with the user 112, and/or any other data. The metadata associated with the user 112 may comprise one or more of the user's Internet browsing history, a frequency of the user's visit to a place of interest, information posted by the user 112 on the social networking website, and/or a review posted by the user 112 on a review website. Examples of implementation of the memory 208 may include, but are not limited to, Random Access Memory (RAM), Read Only Memory (ROM), Hard Disk Drive (HDD), and/or a Secure Digital (SD) card.

In operation, the server computing device 104 may communicate with client computing device 106 via the communication network 108. The receiver 202 may receive the location of the user 112 from the client computing device 106. The receiver 202 may also receive a pre-defined user preference associated with the user 112 from the client computing device 106. The receiver 202 may further receive information about one or more user specified data sources from which the server computing device 104 may receive the data.

When the receiver 202 may receive a data aggregation command from the client computing device 106, the processor 206 may retrieve the user profile and/or the metadata associated with the user 112 from the memory 208. The processor 206 may further create a temporary database for storing data related to the location of the user 112. In an embodiment, the processor 206 may create the temporary database in the memory 208. In another embodiment, the processor 206 may create the temporary database in the database 110.

Based on the data aggregation command received by the receiver 202, the processor 206 may communicate one or more instructions to the one or more data sources, such as the data source(s) 102, to communicate the data. The processor 206 may communicate the one or more instructions via the transmitter 204.

On receiving the one or more instructions from the processor 206, the data source(s) 102 may communicate the data to the server computing device 104. In an embodiment, the social networking server 102a may communicate the data associated with the social networking website, the news server 102b may communicate news related data, the review website server 102c may communicate data related to the reviews posted on the review website, the weather information server may communicate weather information, and the other servers may communicate other data. The communicated data may include the data communicated, either individually or in combination, by the servers, such as the social networking server 102a, the news server 102b, the review website server 102c, the weather information server, and/or other servers.

The receiver 202 may receive the data communicated by the data source(s) 102. The processor 206 may store the received data in the memory 208.

The processor 206 may aggregate the data received from the data source(s) 102. The aggregated received data may correspond to a pre-defined range of the location of the user 112. The pre-defined distance range may correspond to a range of distance around the location of the user 112 from which the user 112 may intend to receive information. For example, the pre-defined distance range may be within 5 miles of the location of the user 112. In an embodiment, from the received data, the processor 206 may aggregate updates about other users within the online social network of the user 112 who are located within the pre-defined distance range from the location of the user 112, information about social gatherings within the pre-defined distance range from the location of the user 112, news feeds related to an area within the pre-defined distance range from the location of the user 112, one or more reviews about restaurants located within the pre-defined distance range from the location of the user 112, one or more reviews about movies showing within the pre-defined distance range from the location of the user 112, events happening within the pre-defined distance range from the location of the user 112, current and/or forecasted weather information about an area within the pre-defined distance range from the location of the user 112, information about local deals in an area within the pre-defined distance range from the location of the user 112, places of interest in an area within the pre-defined distance range from the location of the user 112, and the like.

For example, the data received from the data source(s) 102 data may include review about five restaurants in New York. The user 112 may select 10 miles as the pre-defined distance range. The processor 206 may aggregate reviews about those restaurants which are within 10 miles of the location of the user 112. In an embodiment, all the elements of the received data may correspond to the pre-defined distance range. In such a case, the aggregated data may include all the elements of the received data. In another embodiment, all the elements of the received data may not correspond to the pre-defined distance range. In such a case, the aggregated data may include only those elements of the received data that may correspond to the pre-defined distance range.

The processor 206 may associate at least one tag value with each element of the aggregated received data. The at least one tag value may uniquely identify each element of the aggregated received data. Examples of the at least one tag value may include, but are not limited to, food, an event, a place, news, a sale, and/or a distance range from the location of the user 112. In an embodiment, the processor 206 may define the distance range. In another embodiment, the user 112 may define the distance range using the client computing device 106. In an embodiment, the distance range from the location of the user 112 may be fixed. In an embodiment, the user 112 may adjust the distance range. In an embodiment, the processor 206 may determine the at least one tag value for associating with an element of the aggregated received data based on one or more of a keyword, a data source associated with the each element of the aggregated received data, metadata related to an image, and/or a relationship with the user 112.

For example, an element of the aggregated received data may be a review posted on a food review website. Based on the data source (the food review website), the processor 206 may automatically associate “food” as a tag value with the posted review.

In another example, an element of the aggregated received data may be an image of the Empire State Building. Using an image recognition technique or metadata data associated with the image, the processor 206 may automatically associate “place” as a tag value with the image. The processor 206 may also automatically associate other tag values such as “Empire State Building” and/or “Manhattan sky scraper” with the image.

In another example, an element of the aggregated received data may be a comment with the word “movie”. Based on the keyword, the processor 206 may automatically associate “event” as a tag value with the comment. The processor 206 may also associate names of cast and/or crew of the movie as other tag values associated with the movie.

In another example, an element of the aggregated received data may be a review with the word “theater”. The processor 206 may associate “event” and “place” as tag values with the review. In another example, an element of the aggregated received data may be an image of a burger at a local restaurant. The processor 206 may automatically associate “food” and “place” as the tag values with the image.

The processor 206 may store the aggregated received data having the associated tag values in the memory 208. The processor 206 may temporarily hold the aggregated received data until the server computing device 104 may receive a request from the user 112 for transmitting the data.

When the server computing device 104 may receive the user request for transmitting the data, the processor 206 may process the aggregated received data to generate a set of data associated with the user 112. The processor 206 may generate the set of data from the aggregated received data based on the location of the user 112, an online social network of the user 112 located within the pre-defined distance range of the location, the associated at least one tag value, and/or the pre-defined user preference of the user 112. In an embodiment, the processor 206 may filter the aggregated received data based on the location of the user 112, an online social network of the user 112 located within a pre-defined distance range of the location, the associated at least one tag value, and/or the pre-defined user preference of the user 112 to generate the set of data. The processor 206 may store the generated set of data in the memory 208.

The processor 206 may communicate the generated set of data to the client computing device 106 via the transmitter 204. The processor 206 may communicate the generated set of data in a pre-defined format to the client computing device 106. In an embodiment, the processor 206 may determine the pre-defined format.

In an embodiment, the processor 206 may process the aggregated received data to generate the set of data associated with the user 112 prior to the server computing device 104 receiving the user request for transmitting the data. The processor 206 may temporarily hold the generated set of data until the server computing device 104 may receive the request from the user 112 for transmitting the data. When the server computing device 104 may receive the request from the user 112, the processor 206 may communicate the generated set of data to the client computing device 106.

In an embodiment, the processor 206 may communicate the generated data to the client computing device 106 after a pre-defined time interval, irrespective of receiving the request from the user 112. In an embodiment, the processor 206 may automatically determine the pre-defined time interval. In another embodiment, the user 112 may select the pre-defined time interval. In another embodiment, the processor 206 may randomly communicate the generated set of data at any time.

In an embodiment, in addition to processing the aggregated received data, the processor 206 may generate the set of data based on a weight assigned to each element of the aggregated received data. The processor 206 may assign a weight to each element of the aggregated received data based on one or more parameters. The one or more parameters may comprise one or more of: a distance from the location of the user 112, a demographic profile of the user 112, the metadata associated with the user 112, a time of occurrence of an event, the user's profile, and/or a frequency of the user's visit to a data source. In an embodiment, the user 112 may determine the one or more parameters. The processor 206 may determine the generated set of data based on the assigned weight. In an embodiment, the processor 206 may include one or more elements of the aggregated received data having more weight than a pre-determined weight. The processor 206 may communicate the generated set of data to the client computing device 106 based on of the assigned weight.

For example, the aggregated received data may include a first news feed released 1 hour ago and a second news feed released 2 days ago. The processor 206 may assign weights to both the news feeds. The weight assigned to the first news feed may be higher than the weight assigned to the second news feed since the first news feed may be more updated than the second news feed due to the more recent nature of the first news. The processor 206 may include the first news feed in the generated set of data and communicate the first news feed to the client computing device 106.

In another example, the aggregated received data may include review of a restaurant located 5 miles away from the current location of the user 112 and review of a restaurant located 20 miles away from the current location of the user 112. The user 112 may specify a parameter that information about a location closer to the location of the user 112 is relevant. Based on the user specified parameter, the processor 206 may assign a higher weight to the restaurant located 5 miles away than a weight assigned to the restaurant located 20 miles away. The processor 206 may communicate the review of the restaurant located 5 miles away to the client computing device 106.

In an embodiment, the processor 206 may assign a weight to each data source from which the server computing device 104 may receive the data. The processor 206 may assign the weight to the data source based on one or more parameters. The processor 206 may prioritize the one or more data sources based on the weight assigned to each of the one or more data sources. The server computing device 104 may receive the data from data sources having higher weight and/or priority. For example, when the user 112 may visit a review website more frequently than a social networking website, the processor 206 may assign a higher weight to the review website. The processor 206 may receive more reviews from the review website as compared to receiving updates about online social network of the user 112 from the social networking website.

In an embodiment, the processor 206 may assign a weight to each element of the generated set of data based on the one or more parameters. The processor 206 may prioritize the elements of the generated set of data based on the assigned weights. The processor 206 may communicate the generated set of data to the client computing device 106 based on the weight assigned to each element of the generated set of data. The processor 206 may communicate the elements of the generated set of data that have higher weight and/or priority.

In an embodiment, the processor 206 may receive data based on the received location of the user 112. For example, when the user 112 is in New York, the elements of the received data may include updates from a user's friend in New York, news feed about New York, reviews on restaurants located in New York, and/or information related to events in New York. The processor 206 may aggregate the received data corresponding to the pre-defined distance range from the location of the user 112. The processor 206 may generate the set of data associated with the user 112 from the aggregated received data based on the online social network of the user 112, the at least one tag value associated with each element of the aggregated received data, and/or the pre-defined user preference. The processor 206 may communicate the generated set of data to the client computing device 106.

In an embodiment, the processor 206 may store the received data, the associated tag values, and/or the generated set of data in the database 110.

FIG. 3 is a block diagram of an exemplary client computing device, in accordance with an embodiment of the disclosure. The block diagram of the exemplary client computing device is described in conjunction with the block diagram of FIG. 1 and FIG. 2.

Referring to FIG. 3, there is shown the client computing device 106. The client computing device 106 may comprise an antenna 301, a receiver 302, a transmitter 304, one or more processors, such as a processor 306, a memory 308, a Global Positioning System (GPS) sensor 310, a display screen 312, and an input device 314.

The antenna 301 may be coupled to the receiver 302 and the transmitter 304. Although FIG. 3 shows a single antenna (such as the antenna 301) coupled to the receiver 302 and the transmitter 304, one skilled in the art may appreciate that the receiver 202 and the transmitter 204 may have separate antennas. The processor 306 may be coupled to the receiver 302, the transmitter 304, the memory 208, the GPS sensor 310, the display screen 312, and the input device 314.

The receiver 302 may comprise suitable logic, circuitry, interfaces, and/or code that may be operable to receive data and/or messages. The receiver 302 may receive data and/or messages via the antenna 301. The receiver 302 may receive data in accordance with various known communication protocols. In an embodiment, the receiver 302 may receive the generated set of data from the server computing device 104.

The transmitter 304 may comprise suitable logic, circuitry, interfaces, and/or code that may be operable to communicate data and/or messages. The transmitter 304 may communicate data in accordance with various known communication protocols. In an embodiment, the transmitter 304 may communicate, to the server computing device 104, the user request for transmitting the data. In another embodiment, the transmitter 304 may communicate the location of the user 112 to the server computing device 104. In another embodiment, the transmitter 304 may communicate the data aggregation command to the server computing device 104.

The processor 306 may comprise suitable logic, circuitry, and/or interfaces that may be operable to execute at least one code section stored in the memory 308. The processor 306 may display the generated set of data on the client computing device 106. The processor 306 may further display a user interface on the display screen 312 of the client computing device 106.

The memory 308 may comprise suitable logic, circuitry, and/or interfaces that may be operable to store a machine code and/or a computer program having at least one code section executable by the processor 306. The memory 308 may further store data, such as the generated set of data received from the server computing device 104, at least one code section associated with the GPS sensor 310, and/or at least one code section associated with one or more applications installed on the client computing device 106. Examples of such applications may include, but are not limited to, the client application 114 for communication with the server computing device 104, a social networking application, a web browser application, one or more communication applications such as e-mail and text chat application, games based applications, and/or music based applications. Examples of implementation of the memory 308 may include, but are not limited to, Random Access Memory (RAM), Read Only Memory (ROM), Hard Disk Drive (HDD), and a Secure Digital (SD) card.

The GPS sensor 310 may comprise suitable logic, circuitry, interfaces, and/or code that may be operable to determine the location of the client computing device 106. The GPS sensor 310 may determine the location based on signals received from one or more GPS satellites.

The display screen 312 may comprise suitable logic, circuitry, interfaces, and/or code that may be operable to display a graphical user interface associated with the client computing device 106. The display screen 312 may be implemented using one or more known technologies such as, but not limited to, Liquid Crystal Display (LCD) based display, Light Emitting Diode (LED) based display, and/or Organic LED (OLED) display technology. Further, the display screen 312 may be a touch screen that may receive input from the user 112.

The input device 314 may comprise suitable logic, circuitry, interfaces, and/or code that may be operable to receive input from the user 112. Examples of the input device 314 may include, but are not limited to, a keypad, a stylus, and/or a touch screen.

In operation, the GPS sensor 310 may determine the location of the client computing device 106. The user 112 may initiate the client application 114 for communicating with the server computing device 104. Based on initiation of the client application 114, the client computing device 106 may communicate with the server computing device 104 via the communication network 108. The transmitter 304 may communicate the location of the user 112 to the server computing device 104. The transmitter 304 may also communicate a pre-defined user preference associated with the user 112 to the server computing device 104. The transmitter 304 may further communicate the data aggregation command to the server computing device 104. The data aggregation command may specify the one or more data sources from which the server computing device 104 may receive the data. The processor 306 may communicate the user request for receiving the generated set of data from the server computing device 104.

The receiver 302 may receive the generated set of data associated with the user 112 from the server computing device 104. The processor 306 may display the received set of data on the display screen 312 of the client computing device 106.

In an embodiment, the transmitter 304 may communicate the location of the user 112 to the server computing device 104 based on occurrence of an event. Examples of such an event may include, but are not limited to, change in location of the user 112 and/or change in network service provider. In an embodiment, the processor 306 may prompt the user 112 to enter its location. In another embodiment, the processor 306 may prompt the user 112 to select the location from one or more options displayed on the display screen 312. The user 112 may enter and/or select the location using a user interface displayed on the display screen 312.

In an embodiment, the user 112 may install the client application 114 on the client computing device 106. At the time of installing the client application 114, the processor 306 may display a user interface on the display screen 312 of the client computing device 106. In another embodiment, the processor 306 may display the user interface on the display screen 312 when the user 112 may initiate the client application 114.

The user interface may provide the user 112 with one or more options to specify the one or more data sources from which the server computing device 104 may receive the data. The user interface may also provide the user 112 with one or more options to specify and set-up login details for one or more social networking websites. The server computing device 104 may receive the data from the one or more social networking websites specified by the user 112. The user interface may further provide the user 112 with one or more options to associate at least one tag value with each element of the data received and aggregated by the server computing device 104. The user interface may further provide the user 112 with one or more options to define the user preference. The user interface may further provide the user 112 with one or more options to define a distance range from the location of the user 112 based on which the user 112 may assign at least one tag value with each element of the aggregated received data.

The user interface may further provide the user 112 with one or more options to define a pre-defined format for displaying the received generated set of data on the client computing device 106. The user interface may further provide the user 112 with one or more options to define the one or more parameters. The user interface may further provide the user 112 with one or more options to determine the pre-defined time interval based on which the server computing device 104 may communicate the generated set of data to the client computing device 106. The user 112 may select the one or options using the input device 314.

In an embodiment, the options which the user 112 or the processor 306 may select are tracked by the server computing device 104. The processor 206 of the server computing device 104 tracks the selected option. The server computing device 104 utilizes the selected options to update the user profile.

In an embodiment, the processor 306 may automatically detect the applications installed on the client computing device 106. Based on the applications installed on the client computing device 106, the processor 306 may automatically specify the one or more data sources from which the server computing device 104 may receive the data. In another embodiment, the processor 306 may automatically determine the applications installed on the client computing device 106 and provide the user 112 one or more options to specify one or more applications from the installed applications. Based on the one or more applications specified by the user 112, the processor 306 may specify the one or more data sources from which the server computing device 104 may receive the data.

In another embodiment, the processor 306 may specify the one or more data sources from which the server computing device 104 may receive the data based on the location of the client computing device 106.

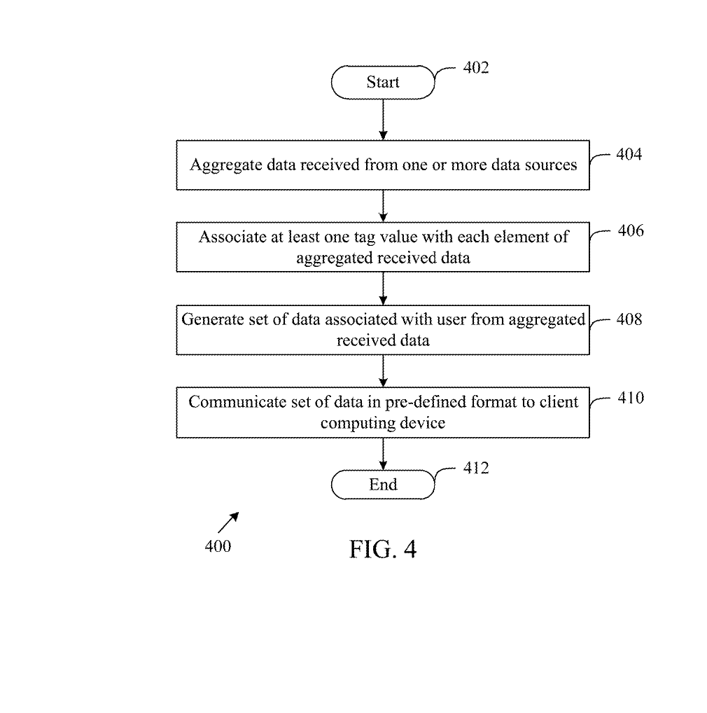

FIG. 4 is a flow chart illustrating exemplary steps for aggregation of data at a server computing device, in accordance with an embodiment of the disclosure. Referring to FIG. 4, there is shown a method 400. The method 400 is described in conjunction with the block diagram of FIG. 1, FIG. 2, and FIG. 3.

Exemplary steps may begin at step 402. At step 404, the server computing device 104 may aggregate data received from one or more data sources, such as the data source(s) 102. The aggregated received data may correspond to a pre-defined range of the location of the user 112. At step 406, the processor 206 may associate at least one tag value with each element of the aggregated received data. The associated at least one tag value may uniquely identify each element of the aggregated received data. At step 408, the processor 206 may generate a set of data associated with the user 112 from the aggregated received data. The processor 206 may generate the set of data based on the location of the user 112, the online social network of the user 112 located within a pre-defined distance range of the location, the at least one tag value, and/or the pre-defined user preference. At step 410, the processor 206 may communicate the set of data in a pre-defined format to the client computing device 106. The method 400 ends at step 412.

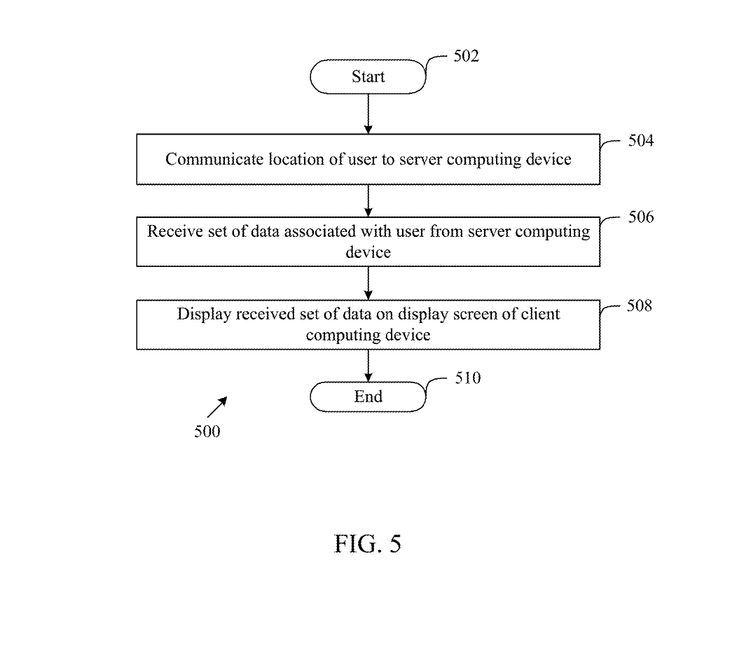

FIG. 5 is a flow chart illustrating exemplary steps for displaying data at a client computing device, in accordance with an embodiment of the disclosure. Referring to FIG. 5, there is shown a method 500. The method 500 is described in conjunction with the block diagram of FIG. 1, FIG. 2, and FIG. 3.

Exemplary steps may begin at step 502. At step 504, the transmitter 304 may communicate the location of the user 112 to the server computing device 104. At step 506, the receiver 302 may receive a set of data associated with the user 112 from the server computing device 104. At step 508, the processor 306 may display the received set of data on the display screen 312 of the client computing device 106. The method 500 ends at step 510.

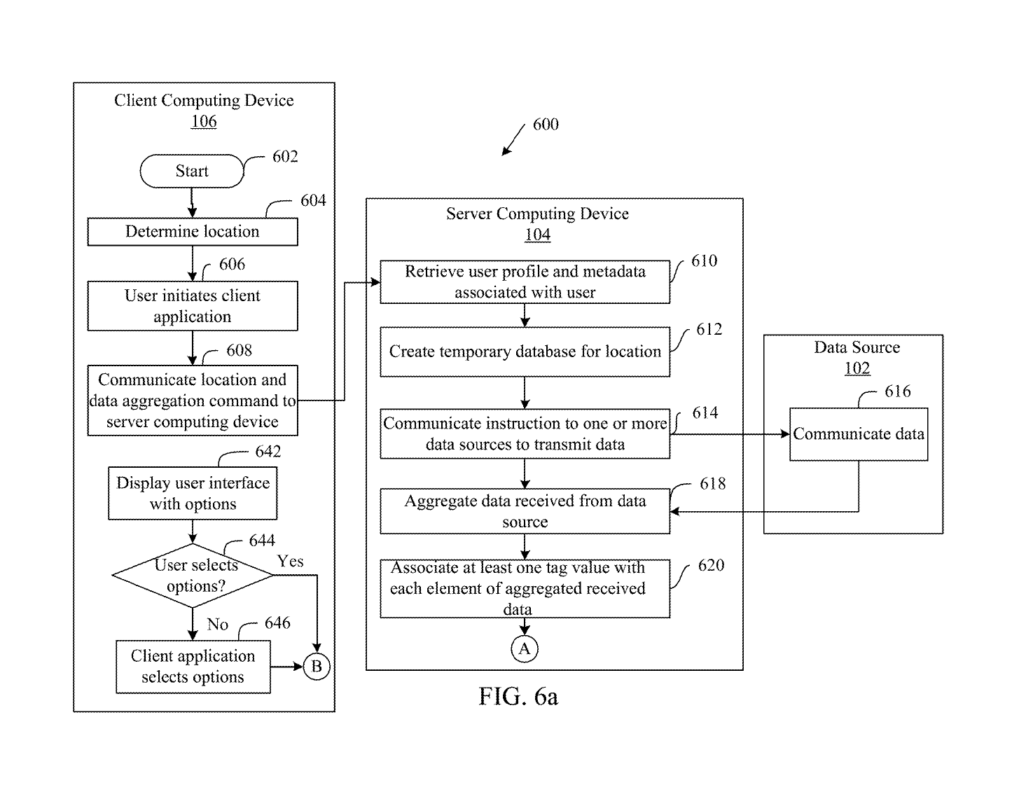

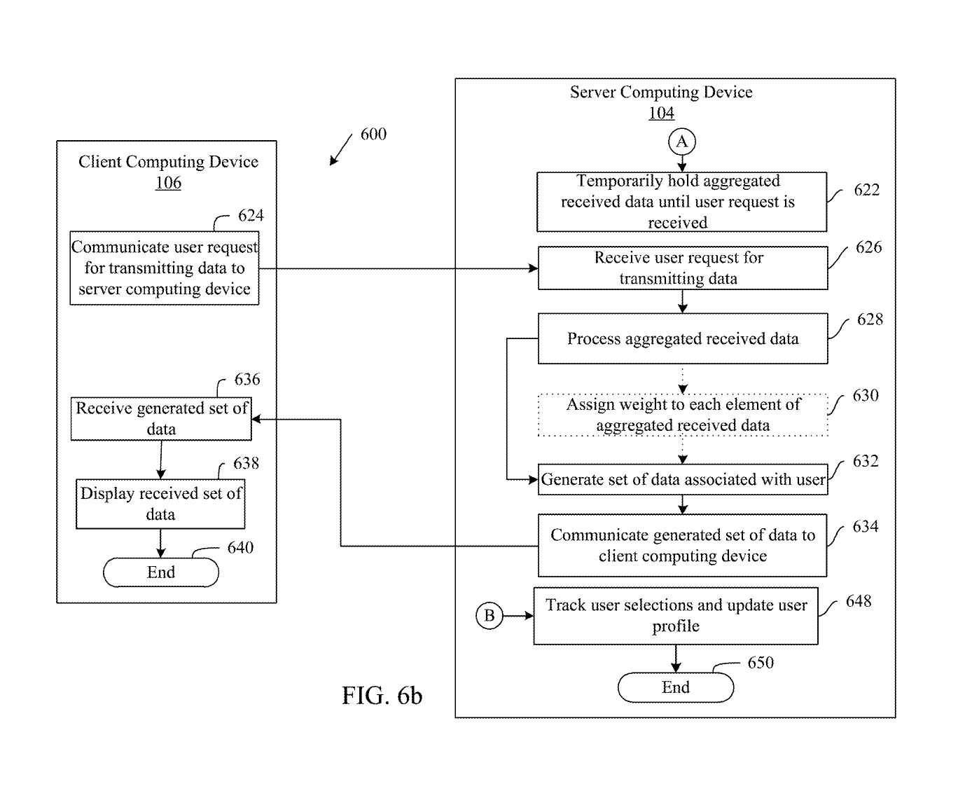

FIG. 6 is a flow chart illustrating exemplary steps for processing information, in accordance with an embodiment of the disclosure. Referring to FIG. 6, there is shown a method 600. The method 600 is described in conjunction with the block diagram of FIG. 1, FIG. 2, and FIG. 3.

Exemplary steps may begin at step 602. At step 604, the client computing device 106 may determine the location of the user 112. The GPS sensor 310 of the client computing device 106 may determine the location of the user 112 via a satellite. At step 606, the user 112 may initiate the client application 114 installed on the client computing device 106. At step 608, the client computing device 106 may communicate the location and the data aggregation command to the server computing device 104. At step 610, based on the received location and the data aggregation command, the server computing device 104 may retrieve the stored user profile and the metadata associated with the user 112. At step 612, the server computing device 104 may create a temporary database for the location of the user 112. At step 614, the server computing device 104 may communicate an instruction to one or more data sources, such as the data source(s) 102, to transmit data. At step 616, based on the instruction received from the server computing device 104, the data source(s) 102, may communicate data to the server computing device 104. At step 618, the server computing device 104 may aggregate the data received from the data source(s) 102. At step 620, the server computing device 104 may associate at least one tag value with each element of the aggregated received data.

At step 622, the server computing device 104 may temporarily hold the aggregated received data until the server computing device 104 may receive a request from the user 112 for transmitting the data. At step 624, the user 112 may communicate the user request to the server computing device 104. At step 626, the server computing device 104 may receive the user request from the client computing device 106. At step 628, based on the received user request, the server computing device 104 may process the aggregated received data. At step 630, the server computing device 104 may optionally assign a weight to each element of the aggregated received data based on one or more parameters.

At step 632, the server computing device 104 may generate a set of data associated with the user 112. The server computing device 104 may generate the set of data based on the processing of the aggregated received data. The server computing device 104 may generate the set of data based on the location of the user 112, online social network of the user 112 located within a pre-defined distance range of the location, the associated at least one tag value, and/or the pre-defined user preference. In an embodiment, the server computing device 104 may generate the set of data based on the weight assigned to each element of the aggregated received data. At step 634, the server computing device 104 may communicate the generated set of data in a pre-defined format to the client computing device 106. At step 636, the client computing device 106 may receive the set of data from the server computing device 104. At step 638, the client computing device 106 may display the received set of data on the display screen 312 of the client computing device 106. The method 600 ends at step 640.

In addition to the above mentioned steps, at step 642, the client computing device 106 may display a user interface on the display screen 312 of the client computing device 106. The user interface may provide the user 112 one or more options to select.

At step 644, the client computing device 106 may determine whether the user 112 selects one or more options from the options provided by the user interface. If at step 644, the client computing device 106 may determine that the user 112 selects one or more options from the options provided by the user interface, the method may proceed to step 648. However, if at step 644, the client computing device 106 may determine that the user 112 does not select one or more options from the options provided by the user interface, the method may proceed to step 646. At step 646, the client application 114 may automatically select the one or more options from the options provided by the user interface. At step 648, the server computing device 104, may track the selected one or more options and update the user profile. The method ends at step 650.

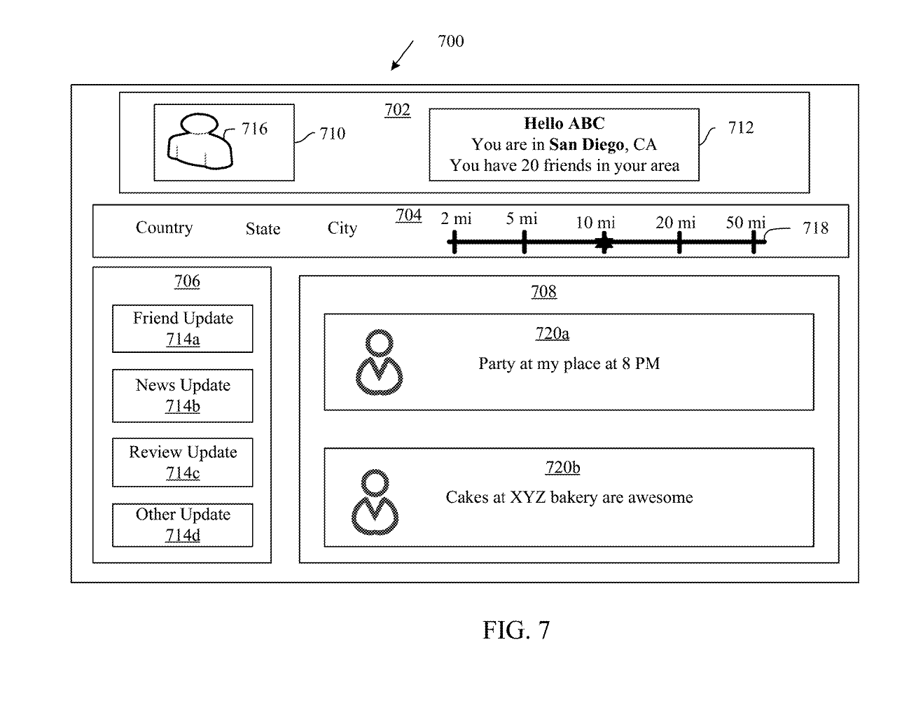

FIG. 7 is an exemplary user interface displayed on a client computing device, in accordance with an embodiment of the disclosure. The exemplary user interface displayed on the client computing device is described in conjunction with the block diagram of FIG. 1, FIG. 2, and FIG. 3.

Referring to FIG. 7, there is shown a user interface 700 displayed on the display screen 312 of the client computing device 106. The user interface 700 may comprise a user information region 702, a setting control region 704, an update control region 706, and an update region 708.

The user information region 702 may comprise an image region 710 and a message region 712. The update control region 706 may comprise one or more update options selectable by the user 112. Such update options may include a friend update 714a, a news update 714b, a review update 714c, and other update 714d.

The image region 710 may display an image 716. The image 716 corresponds to an image of the user 112 associated with the client computing device 106. As shown in FIG. 7, the message region 712 may display a welcome note for the user 112, the location of the user 112, and/or other messages for the user 112.

The setting control region 704 may provide one or more options to the user 112 to select the location and specify a pre-defined distance range around the location from which the user 112 may intend to receive updates. The user 112 may specify the pre-defined distance range by sliding through a distance scale 718 of the setting control region 704. Although not shown in FIG. 7, the setting control region 704 may also provide one or more options to the user 112 to define one or more parameters for assigning weight to elements of the data received and aggregated by the server computing device 104, elements of the set of data generated by the server computing device 104, and/or one or more data sources, set-up login details for one or more social networking websites, define preferences, and the like.

The user 112 may specify a data source from which the server computing device 104 may receive the data by selecting one or more options from the update control region 706. The user 112 may select the social networking server 102a as the data source by selecting the friend update 714a. Similarly, the user 112 may select the news server 102b as the data source by selecting the news update 714b. Similarly, by selecting review update 714c, the user 112 may select the review website server 102c as the data source. Further, the user 112 may specify other servers as data sources by selecting the other update 714d.

The update region 708 may display one or more updates, such as 720a and 720b, corresponding to the generated set of data that the client computing device 106 may receive from the server computing device 104.

For example, as shown in FIG. 7, the user 112 is in San Diego. The client computing device 106 may communicate the location of the user 112 (i.e. San Diego) to the server computing device 104. The user 112 may specify that he wants to receive data about friends, events, places, etc., located within 10 miles of the location. The user 112 may select the friend update 714a and the review update 714c. Based on the location of the user 112 and the one or more options selected by the user 112, the client computing device 106 may receive updates regarding friends in San Diego who are within 10 miles of the location. The client computing device 106 may display the received updates regarding friends as the update 720a. Similarly, the client computing device 106 may display reviews about restaurants located within 10 miles of the location as the update 720b.

In accordance with another embodiment of the disclosure, a method and/or system for processing information may comprise one or more processors, such as a processor 206 (FIG. 2), in a server computing device 104 (FIG. 1). The one or more processors may be operable to receive data corresponding to a user 112 (FIG. 1) from one or more data sources, such as the data source(s) 102 (FIG. 1). The data may be received based on a location of the user 112. The one or more processors may be operable to aggregate the received data corresponding to the user 112. The aggregated received data may correspond to a pre-defined distance range from the location of the user 112. The one or more processors may be operable to associate at least one tag value with each element of the aggregated received data. The associated at least one tag value may uniquely identify each element of the aggregated received data.

The one or more processors may be operable to generate a set of data associated with the user 112 from the aggregated received data based on one or more of: the location of the user 112, an online social network of the user 112 located within the pre-defined distance range, the associated at least one tag value, and/or a pre-defined user preference of the user 112. The one or more processors may be operable to assign a weight to each element of the generated set of data based on one or more of a distance from the location of the user 112, a demographic profile of the user 112, metadata associated with the user 112, a time of occurrence of an event, the user's profile, and/or a frequency of the user's visit to a data source. The one or more processors may be operable to communicate the generated set of data to a client computing device 106 (FIG. 1) based on the weight assigned to each element of the generated set of data.

In accordance with another embodiment of the disclosure, a method and/or system for processing information may comprise one or more processors, such as a processor 306 (FIG. 3) in a client computing device 106 (FIG. 1) associated with a user 112 (FIG. 1). The one or more processors may be operable to communicate a location of the user 112 to a server computing device 104 (FIG. 1). The one or more processors may be operable to receive a set of data associated with the user 112. The set of data may correspond to a pre-defined distance range from the location of the user 112. The one or more processors may be operable to display the received set of data on the client computing device 106.

The one or more processors may be operable to display a user interface on the client computing device 106. The user interface may enable the user 112 to perform one or more of selecting the one or more data sources, such as the data source(s) 102, defining a user preference of the user 112, defining a pre-defined format for displaying the received set of data on the client computing device 106, determining a pre-defined time interval for receiving the set of data, defining a distance range from the location of the user 112 for receiving the set of data, and/or defining one or more parameters for assigning a weight to the each element of the received set of data.

Other embodiments of the disclosure may provide a non-transitory computer readable medium and/or storage medium, and/or a non-transitory machine readable medium and/or storage medium, having stored thereon, a machine code and/or a computer program having at least one code section for processing information, the at least one code section being executable by a machine and/or a computer, thereby causing the machine and/or computer to perform the step comprising, in a server computing device, aggregating data associated with a user received from one or more data sources. The aggregated received data may be corresponds to a pre-defined distance range from a location of the user. The step may comprise associating at least one tag value with each element of the aggregated received data. The associated at least one tag value may uniquely identify each element of the aggregated received data.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for processing information, said method comprising:
in a server computing device:
aggregating data associated with a user that is received from one or more data sources, wherein said aggregated said received data corresponds to a pre-defined distance range from a location of said user; and
associating at least one tag value with each element of said aggregated said received data, wherein said associated at least one tag value uniquely identifies each element of said aggregated said received data.

2. The method of claim 1, comprising generating a set of data associated with said user from said aggregated said received data based on one or more of: said location of said user, an online social network of said user located within said pre-defined distance range, said associated at least one tag value, and/or a pre-defined user preference of said user.

3. The method according to claim 2, comprising communicating said generated set of data in a pre-defined format to a client computing device.

4. The method of claim 2, comprising assigning a weight to each said element of said aggregated said received data based on one or more parameters.

5. The method of claim 4, wherein said generated set of data is determined based on said assigned weight.

6. The method of claim 4, wherein said one or more parameters comprises one or more of: a distance from said location of said user, a demographic profile of said user, metadata associated with said user, a time of occurrence of an event, said user's profile, and/or a frequency of said user's visit to a data source.

7. The method of claim 6, wherein said metadata associated with said user comprises one or more of: said user's Internet browsing history, a frequency of said user's visit to a place of interest, information posted by said user on a social networking website, and/or a review posted by said user on a review website.

8. The method of claim 1, wherein said one or more data sources are selected by said user.

9. The method of claim 1, wherein said one or more data sources comprises one or more of: a social networking server, a news server, a review website server, and/or a weather information server.

10. The method of claim 1, comprising receiving said location of said user from said client computing device.

11. The method of claim 1, wherein said received data comprises one or more of: a user profile of said user, user profiles of other users within said online social network of said user, an update associated with said online social network of said user, information about social gatherings, information posted by said user and/or said other users on a social networking website, news feeds, news related to a local area, event information from a local news website, one or more reviews about food, restaurants, books, movies, people, products, and/or events, current and/or forecasted weather information about an area, information about local deals in an area, places of interest in an area, and/or advertisements related to local products.

12. The method of claim 1, wherein said associated at least one tag value is determined based on one or more of: a keyword, a data source associated with each said element of said aggregated said received data, metadata related to an image, and/or a relationship with said user.

13. The method of claim 1, wherein said associated at least one tag value comprises one or more of: food, an event, a place, news, a sale, or a distance range from said location of said user.

14. A system for processing information, said system comprising:
one or more processors in a client computing device associated with a user, said one or more processors being operable to:
communicate a location of said user to a server computing device;
receive a set of data associated with said user, wherein said received set of data corresponds to a pre-defined distance range from said location of said user; and
display said received set of data on said client computing device.

15. The system of claim 14, wherein said one or more processors are operable to display a user interface on said client computing device, wherein said user interface enables said user to perform one or more of: selecting said one or more data sources, defining a user preference of said user, defining a pre-defined format for displaying said received set of data on said client computing device, determining a pre-defined time interval for receiving said set of data, defining a distance range from said location of said user for receiving said set of data, and/or defining one or more parameters for assigning a weight to each said element of said received set of data.

16. A system for processing information, said system comprising:
one or more processors in a server computing device, said one or more processors being operable to:
receive data corresponding to a user from one or more data sources, wherein said data is received based on a location of said user;
aggregate said received data corresponding to said user, wherein said aggregated said received data corresponds to a pre-defined distance range from said location of said user; and
associate at least one tag value with each element of said aggregated said received data, wherein said associated at least one tag value uniquely identifies each element of said aggregated said received data.

17. The system according to claim 16, wherein said one or more processors are operable to generate a set of data associated with said user from said aggregated said received data based on one or more of: said location of said user, an online social network of said user located within said pre-defined distance range, said associated at least one tag value, and/or a pre-defined user preference of said user.

18. The system of claim 17, wherein said one or more processors are operable to assign a weight to each said element of said generated set of data based on one or more of: a distance from said location of said user, a demographic profile of said user, metadata associated with said user, a time of occurrence of an event, said user's profile, and/or a frequency of said user's visit to a data source.

19. The system of claim 18, wherein said one or more processors are operable to communicate said generated set of data to a client computing device based on said weight assigned to each said element of said generated set of data.

20. A method for processing information, said method comprising:
in a client computing device associated with a user:
communicating a location of said user to a server computing device;
receiving a set of data associated with said user, wherein said received set of data corresponds to a pre-defined distance range from a location of said user; and
displaying said received set of data on said client computing device.
